(19) United States
(12) Patent Application Publication
(10) Pub. No.: US 2015/0178770 A1
(43) Pub. Date: Jun. 25, 2015

(54) PRODUCT ADVERTISEMENT MANAGEMENT SYSTEM AND METHOD

(71) Applicant: NVISTA CO., LTD., SEOUL (KR)

(72) Inventors: WOO DONG LEE, SEOUL (KR); HYE RIM OH, SEONGNAM-SI (KR)

(73) Assignee: NVISTA CO., LTD., SEOUL (KR)

(21) Appl. No.: 14/151,663

(22) Filed: Jan. 9, 2014

(30) Foreign Application Priority Data
Dec. 23, 2013 (KR) 10-2013-0161710

(51) Int. Cl. G06Q 30/02

(52) U.S. Cl. CPC G06Q 30/0246; G06Q 30/0269; G06Q 30/0275

(57) ABSTRACT

The product advertisement management system is connected to an online marketplace and a marketplace system. An input interface unit receives advertisement bidding information which comprises a product number and a bidding price. An advertisement processing unit combines the advertisement bidding information with data of an advertiser product database (DB). A category-keyword matching unit receives product click information which comprises an input keyword, product categories and the numbers of product clicks and selects a matching category which is to be matched with the input keyword. A control unit displays product information, which corresponds to the matching category matched with a search keyword of the online marketplace or corresponds to a search category, in order of bidding price. The category-keyword matching unit selects a product category with a largest number of product clicks as the matching category among the product categories having the input keyword same.

### RELATED APPLICATION

This application claims priority from Korean Patent Application No. 10-2013-0161710 filed on Dec. 23, 2013 in the Korean Intellectual Property Office, the disclosure of which is incorporated herein by reference in its entirety.

### BACKGROUND OF THE INVENTION

1. Field of the Invention

The present inventive concept relates to a product advertisement management system and method, and more particularly, to a product advertisement management system and method using category-keyword matching.

2. Description of the Related Art

The widespread establishment of the Internet network is rapidly increasing the number of buyers who purchase products through online shopping malls. Accordingly, the number of sellers who sell products through online shopping malls is also increasing rapidly. Generally, sellers use advertisement service provided by online shopping malls as part of marketing activities for selling products.

To use advertisement service provided by an online shopping mall, an advertiser has to match a product to be promoted with a search keyword. Accordingly, the product matched with the keyword is displayed in a corresponding advertisement section of the online shopping mall.

Here, the advertiser intending to use the advertisement service of the online shopping mall has to match a search keyword with each product to be advertised as part of marketing activities for selling products in the online shopping mall. In addition, the advertiser has to input advertisement information that is to be exposed whenever a corresponding advertisement is clicked. Furthermore, the advertiser has to create a landing page by himself or herself That is, a lot of time and cost are required.

### SUMMARY OF THE INVENTION

Aspects of the present inventive concept provide a product advertisement management system which increases the convenience of advertisers and the efficiency of advertising through category-keyword matching.

Aspects of the present inventive concept also provide a product advertisement management method which increases the convenience of advertisers and the efficiency of advertising through category-keyword matching.

However, aspects of the present inventive concept are not restricted to the one set forth herein. The above and other aspects of the present inventive concept will become more apparent to one of ordinary skill in the art to which the present inventive concept pertains by referencing the detailed description of the present inventive concept given below.

According to an aspect of the present inventive concept, there is provided A product advertisement management system connected to an online marketplace and a marketplace system, the product advertisement management system including an input interface unit receiving advertisement bidding information which comprises a product number and a bidding price, an advertisement processing unit combining the advertisement bidding information with data of an advertiser product database (DB), a category-keyword matching unit receiving product click information which comprises an input keyword, product categories and the numbers of product clicks and selecting a matching category which is to be matched with the input keyword, and a control unit displaying product information, which corresponds to the matching category matched with a search keyword of the online marketplace or corresponds to a search category, in order of bidding price, wherein the category-keyword matching unit selects a product category with a largest number of product clicks as the matching category among the product categories corresponding to the same input keyword.

According to another aspect of the present inventive concept, there is provided a product advertisement management method, the product advertisement management method including receiving a search keyword or a search category online, extracting product information which corresponds to a matching category for a preset input keyword that matches the received search keyword or product information which corresponds to the received search category, displaying the product information in a preset order of bidding price, wherein the matching category is a product category with a largest number of product clicks among product categories corresponding to the same input keyword.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a diagram illustrating a product advertisement management system according to an embodiment of the present inventive concept;

FIG. 2 is a diagram illustrating the operation of the product advertisement management system of FIG. 1;

FIGS. 3A and 3B are tables for explaining the operation of a category-keyword matching unit of the product advertisement management system of FIG. 1;

FIGS. 4A through 4D are tables for explaining the operation of the product advertisement management system of FIG. 1;

FIG. 5 is a diagram illustrating a product advertisement management system according to another embodiment of the present inventive concept;

FIG. 6 is a flowchart illustrating a product advertisement management method according to an embodiment of the present inventive concept;

FIGS. 7A and 7B are flowcharts illustrating a product advertisement management method according to another embodiment of the present inventive concept;

FIG. 8 is a flowchart illustrating an operation of receiving advertiser product information of FIGS. 7A and 7B; and

FIG. 9 is a flowchart illustrating a product advertisement management method according to another embodiment of the present inventive concept.

### DETAILED DESCRIPTION OF THE INVENTION

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

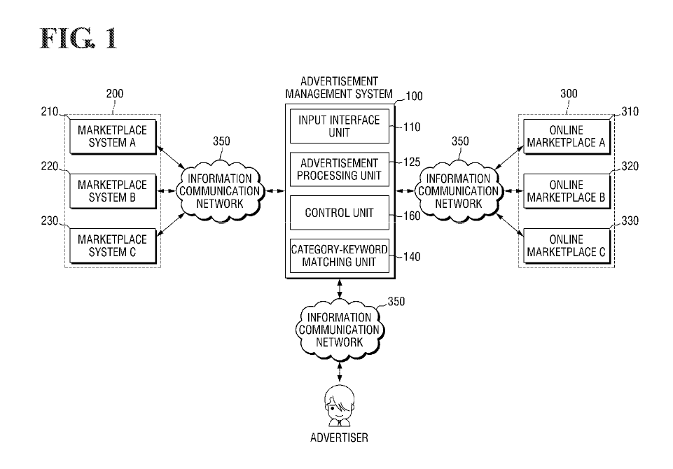

FIG. 1 is a diagram illustrating a product advertisement management system 100 according to an embodiment of the present inventive concept.

Referring to FIG. 1, the product advertisement management system 100 according to the current embodiment includes an input interface unit 110, an advertisement processing unit 125, a control unit 160, and a category-keyword matching unit 140.

The product advertisement management system 100 may be connected to an online marketplace 300, a marketplace system 200, or a user through an information communication network 350. The product advertisement management system 100 may be connected to a plurality of online marketplaces 300. In addition, the product advertisement management system 100 may be connected to a plurality of marketplace systems 200. However, the present inventive concept is not limited thereto.

The online marketplace 300 may be defined as, in a broad sense, an online shopping mall where business transactions are conducted based on a website. The online marketplace 300 may include an online product brokerage site which acts as an intermediary between sellers and buyers. The online marketplace 300 may include an online bidding shopping site where a buyer submits a bidding price for a product registered by a seller and is awarded the product if the buyer is the highest bidder. The online marketplace 300 may include an advertisement section (not shown) where product advertisements are exposed.

Product information provided by the product advertisement management system 100 may be displayed in the advertisement section (not shown). Clicking on the product information displayed in the advertisement section (not shown) may take a user of the online marketplace 300 to a product detail page (not shown). In this case, an amount corresponding to a bidding price for the product information may be deducted from an amount of charged money of an advertiser. This will be described in detail later.

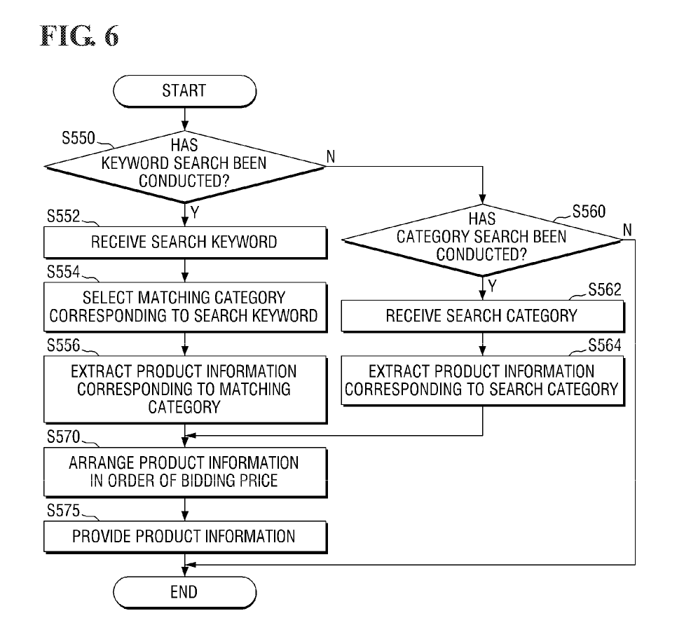

The marketplace system 200 may operate or manage the online marketplace 300 or provide service to users. The marketplace system 200 may store and control data of the online marketplace 300. The marketplace system 200 may include a marketplace seller information database (DB) 250, a product advertisement copying unit 260, a seller product DB 27, and a keyword and product click information DB 280. These elements will be described in detail later with reference to FIG. 5.

The information communication network 350 may connect the product advertisement management system 100 to the marketplace system 200, the product advertisement management system 100 to the online marketplace 300, and the product advertisement management system 100 to a user (e.g., an advertiser). The information communication network 350 may transmit data using a preset communication protocol. The preset communication protocol may be any one of a TCP/IP protocol, an IEEE 802.11 protocol, and a wireless application protocol (WAP).

The information communication network 350 may connect the product advertisement management system 100 to a plurality of marketplace systems 200. The information communication network 350 may connect the product advertisement management system 100 to a plurality of online marketplaces 300. A user may access the product advertisement management system 100 through the information communication network 350, but the present inventive concept is not limited thereto.

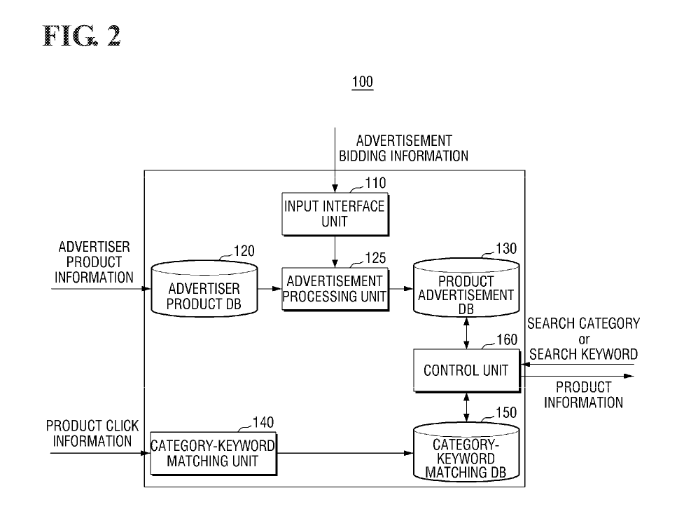

FIG. 2 is a diagram illustrating the operation of the product advertisement management system 100 of FIG. 1.

Referring to FIG. 2, the product advertisement management system 100 according to the current embodiment may further include an advertiser product DB 120, a product advertisement DB 130, and a category-keyword matching DB 150.

The input interface unit 110 may receive advertisement bidding information which includes a product number and a bidding price. For example, the input interface unit 110 may receive the advertisement bidding information from an advertiser through the information communication network 350, but the present inventive concept is not limited thereto. The input interface 110 may send received data to the advertisement processing unit 125. For example, the input interface unit 110 may send the advertisement bidding information input by the advertiser to the advertisement processing unit 125.

An advertiser may input a product number of a product that he or she desires to advertise and a bidding price corresponding to an advertising rate. The advertisement bidding information can be modified whenever the advertiser desires.

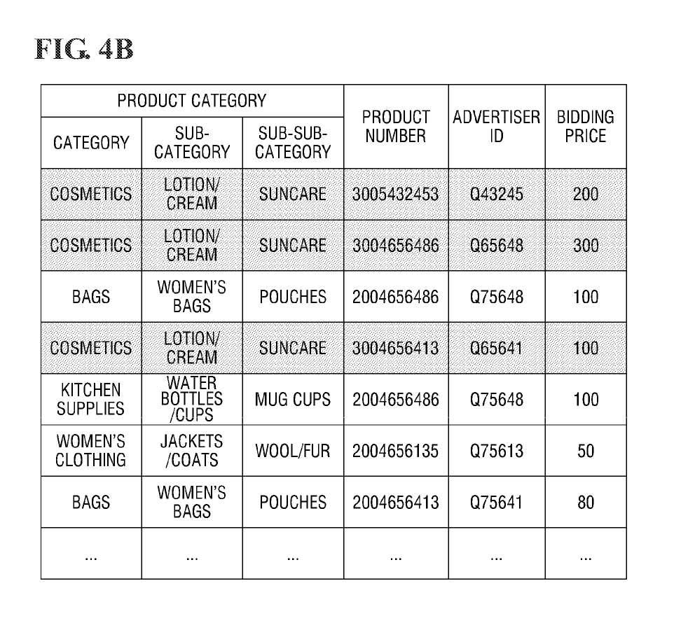

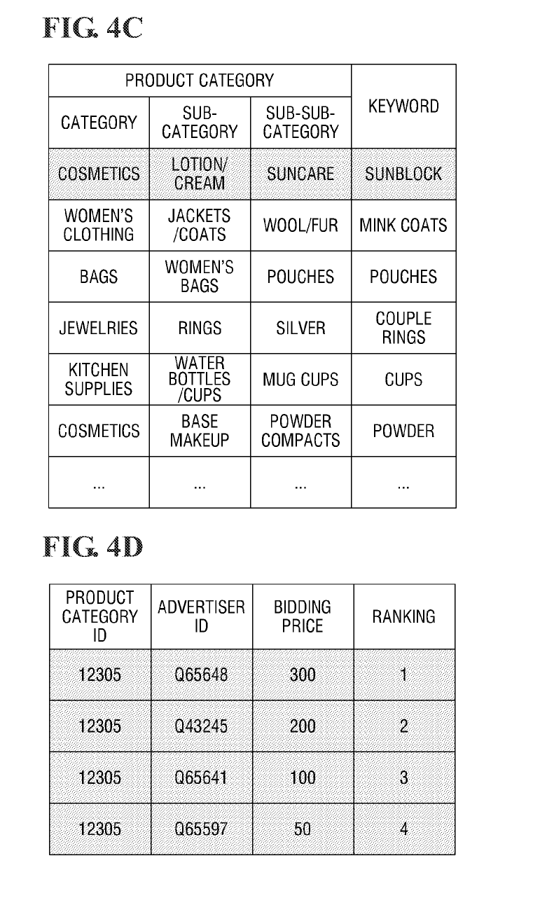

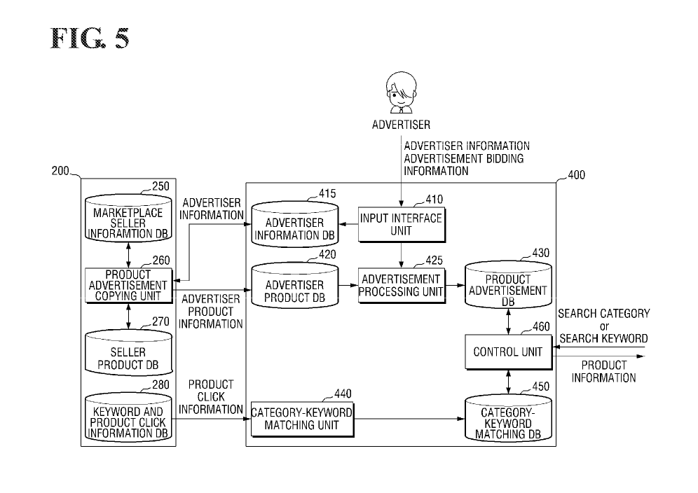

The advertiser product DB 120 may receive product information of an advertiser. For example, the advertiser product DB 120 may receive product information registered with the marketplace system 200 from the marketplace system 200. The advertiser product information may include an advertiser ID, a product number, or a product category. For example, referring to FIG. 4A, product information in a first row of the table may include ‘nvistal’ as an advertiser ID, ‘3005432453’ as a product number, and ‘cosmetics (category)-lotion/cream (sub-category)-suncare (sub-sub-category)’ as a product category, but the present inventive concept is not limited thereto. Thus, there is no need for an advertiser to input information about the same product again to the product advertisement management system 100. The advertiser product DB 120 may select products of advertisers registered with the product advertisement management system 100 and receive information about the products.

The advertisement processing unit 125 may be connected to the advertiser product DB 120, the input interface unit 110, and the product advertisement DB 130. The advertisement processing unit 125 may receive data from the advertiser product DB 120 and the input interface unit 110. The advertisement processing unit 125 may combine the advertisement bidding information and the data of the advertiser product DB 120 and send the combined data to the product advertisement DB 130. Specifically, the advertisement processing unit 125 may search the advertiser product DB 120 for a product number that matches a product number in the advertiser product information and add a bidding price to a product corresponding to the product number. The advertisement processing unit 125 may send the combined data to the product advertisement DB 130, but the present inventive concept is not limited thereto.

The product advertisement DB 130 may be connected to the advertisement processing unit 125 and the control unit 160. The product advertisement DB 130 may include product information including a bidding price. The product advertisement DB 130 may provide the product information at the request of the control unit 160.

The category-keyword matching unit 140 may receive product click information including an input keyword, product categories, and the numbers of product clicks. For example, the category-keyword matching unit 140 may receive the product click information from the online marketplace 300, but the present inventive concept is not limited thereto.

The input keyword is a keyword used by a user to find products in the marketplace system 200. The product categories are categories of products found using the input keyword and then clicked. Each of the numbers of product clicks is the number of clicks on one of the products. The category-keyword matching unit 140 may match a product category with the input keyword and send the matched product category and input keyword to the category-keyword matching DB 150.

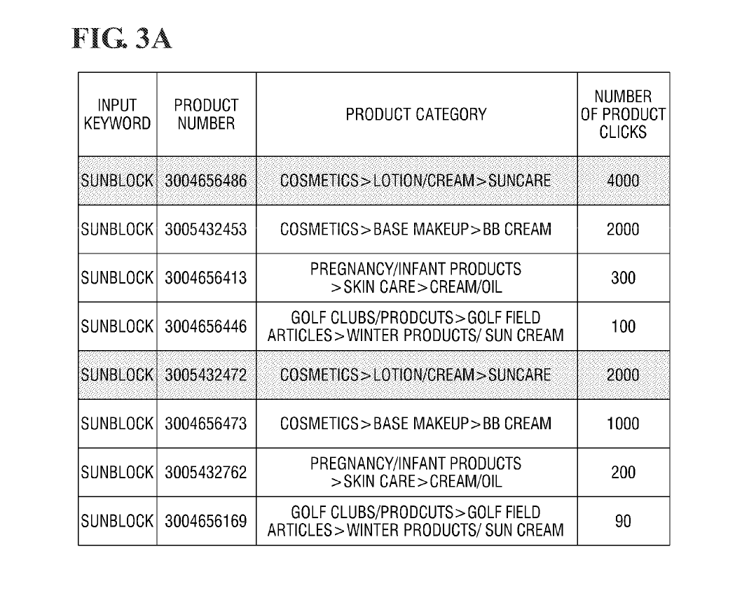

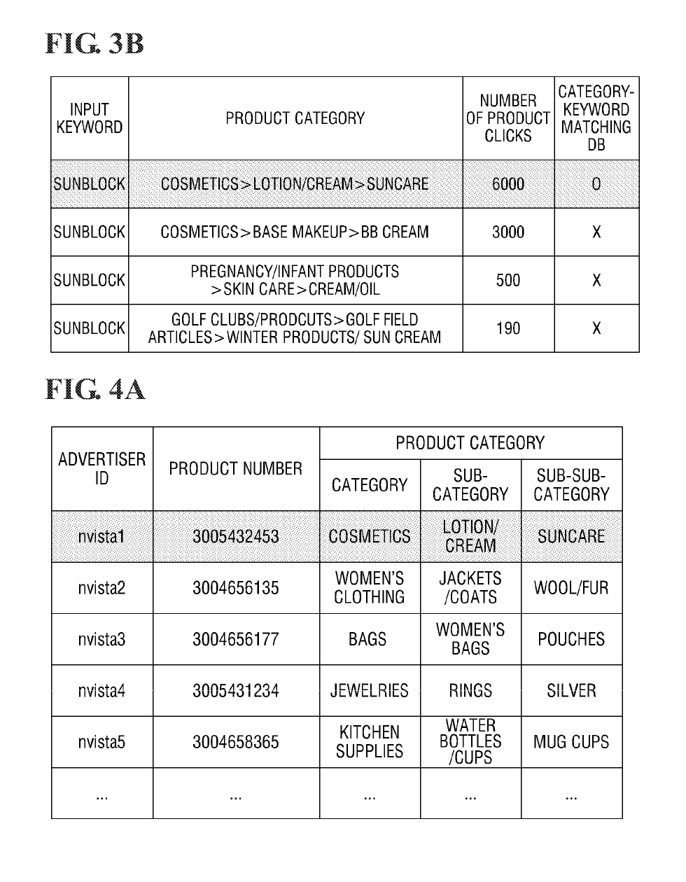

Specifically, the category-keyword matching unit 140 may match the input keyword with a product category that receives a largest number of product clicks among product categories corresponding to the same input keyword. The category-keyword matching unit 140 may accumulate the number of product clicks on records corresponding to the same product category and the same input keyword. This will be described in detail later with reference to FIGS. 3A and 3B.

The category-keyword matching DB 150 may be connected to the category-keyword matching unit 140 and the control unit 160. The category-keyword matching DB 150 may store data about an input keyword and a matching category. At the request of the control unit 160, the category-keyword matching DB 150 may send information about a matching category corresponding to an input keyword which is the same as a search keyword.

The control unit 160 may be connected to the product advertisement DB 130 and the category-keyword matching DB 150. The control unit 160 may receive information about a search keyword or a search category. For example, the control unit 160 may receive the information from the online marketplace 300, but the present inventive concept is not limited thereto. The control unit 160 may determine a matching category that matches the search keyword of the online marketplace 300 by using the category-keyword matching DB 150. Then, the control unit 160 may arrange products corresponding to the matching category based on bidding price by using the product advertisement DB 130. For example, the control unit 160 may display information about the products in order of highest to lowest bidding price in the advertisement section (not shown) of the online marketplace 300. However, the present inventive concept is not limited thereto, and the control unit 160 may also send the data arranged in order of bidding price to another medium.

FIGS. 3A and 3B are tables for explaining the operation of the category-keyword matching unit 140 of the product advertisement management system 100 of FIG. 1.

The table of FIG. 3A shows product click information. Referring to a first row of the table, a product corresponding to a product number ‘3004656486’ was found using an input keyword ‘sunblock.’ A product category of the product is ‘cosmetics-lotion/cream-suncare,’ and the number of clicks on the product is 4,000. The category-keyword matching unit 140 may receive product click information including an input keyword, product numbers, product categories or the numbers of products clicks as shown in FIG. 3A. For example, the category-keyword matching unit 140 may receive the product click information from the marketplace system 200. However, the present inventive concept is not limited thereto, and the category-keyword matching unit 140 may also receive the product click information from another device.

The table of FIG. 3B shows matching categories arranged in order of the number of product clicks.

The category-keyword matching unit 140 extracts data corresponding to the same product category and the same input keyword from received product click information. The category-keyword matching unit 140 accumulates the number of product clicks of the extracted data. Accordingly, records corresponding to the same product category and the same input keyword may be combined into one record. Then, the category-keyword matching unit 140 may arrange the record in order of largest to smallest number of product clicks and select a product category with the largest number of product clicks from the product categories corresponding to the same input keyword. For each input keyword, a product category with the largest number of product clicks may be selected as a matching category and may be matched with a corresponding input keyword. The input keyword and the matching category that are matched with each other may be sent to the category-keyword matching DB 150, but the present inventive concept is not limited thereto.

As described above, among products found in a marketplace using an input keyword and then clicked, a category of a product that receives a largest number of clicks is selected as a matching category. Then, an advertisement is provided based on the matching category, thereby improving the efficiency of advertising. In addition, keyword information is not input for each product to be advertised. Instead, a product with a highest bidding price in each product category may be preferentially advertised, or a product with a highest bidding price in a matching category that matches a search keyword of a user may be preferentially advertised. This can increase the convenience of advertisers.

FIGS. 4A through 4D are tables for explaining the operation of the product advertisement management system 100 of FIG. 1.

The table of FIG. 4A shows data stored in the advertiser product DB 120. The data may be advertiser product information. For example, product information in the first row of the table may include ‘nvistal’ as an advertiser ID, ‘3005432453’ as a product number, and ‘cosmetics (category)-lotion/cream (sub-category)-suncare (sub-sub category)’ as a product category, but the present inventive concept is not limited thereto. The advertiser product information may be received from the marketplace system 200. The advertiser product information may be information about an advertiser ID registered with the product advertisement management system 100. The advertiser product information may include an advertiser ID, a product number, or a product category. The product category may be classified into a category, a sub-category, and a sub-sub-category.

Different advertiser product information may be stored in the advertiser product DB 120 for each marketplace system 200. For example, when advertiser product information of marketplace system A (210), advertiser product information of marketplace system B (220), and advertiser product information of marketplace system C (230) are different, they may be managed separately for each marketplace system. However, the present inventive concept is not limited thereto, and the advertiser product information of each marketplace system 200 may also be combined and managed separately for each advertiser.

The table of FIG. 4B shows data stored in the product advertisement DB 130. The data may include advertiser product information and information about bidding prices. The data may be received from the advertisement processing unit 125. The advertisement processing unit 125 may compare data of the advertiser product DB 120 with advertisement bidding information received through the input interface unit 110 and add a bidding price item to the data of the advertiser product DB 120. Specifically, the advertisement processing unit 125 may compare a product number included in the advertisement bidding information with a product number in the advertiser product DB 120 and add a bidding price to a product corresponding to the product number. Accordingly, the data of the product advertisement DB 130 may include product category, product number, advertiser ID or bidding price items.

The table of FIG. 4C shows data stored in the category-keyword matching DB 150. The data may include information about categories and input keywords that are matched by the category-keyword matching unit 140. One input keyword may have one matching category. The matching category may be classified into a category, a sub-category, and a sub-sub-category. The matching category is a category selected most frequently by users from categories of products found using an input keyword.

The table of FIG. 4D shows data arranged in order of bidding price by the control unit 160. The data may include product category IDs, advertiser IDs, bidding prices, or rankings. A product category ID may be assigned to each category, each sub-category, or each sub-sub-category. For example, if a category, a sub-category, and a sub-sub category are all for the same product, they may have the same product category ID.

The control unit 160 may receive information about a search keyword or a search category.

When receiving a search keyword, the control unit 160 may search the category-keyword matching DB 150 for an input keyword that is the same as the search keyword. Then, the control unit 160 may receive information about a matching category that matches the found input keyword. The control unit 160 may receive information about records that belong to the same product category as the matching category from the product advertisement DB 130. The received record may be arranged and ranked in order of bidding price. For example, the received records may be ranked in order of highest to lowest bidding price. The control unit 160 may provide product information in order of highest to lowest rank.

When receiving a search category, the control unit 160 may receive information about records that belong to the same product category as the search category from the product advertisement DB 130. The received records may be arranged and ranked in order of bidding price. For example, the received records may be ranked in order of highest to lowest bidding price. The control unit 160 may provide product information in order of highest to lowest rank, but the present inventive concept is not limited thereto.

FIG. 5 is a diagram illustrating a product advertisement management system 400 according to another embodiment of the present inventive concept.

Referring to FIG. 5, the product advertisement management system 400 according to the current embodiment may be substantially identical to the product advertisement management system 100 described above with reference to FIGS. 1 through 4D. For simplicity, the current embodiment will be described, focusing mainly on differences with the embodiment of FIGS. 1 through 4D.

The product advertisement management system 400 may include an advertiser information DB 415 which stores advertiser information. The advertiser information DB 415 may be connected to an input interface unit 410.

An advertiser may input information about himself or herself through the input interface unit 410. The input interface unit 410 may receive advertiser information and send the advertiser information to the advertiser information DB 415. The advertiser information DB 415 may send the advertiser information to a marketplace system 200, and an advertiser product DB 420 may receive the advertiser product information from the marketplace system 200.

The marketplace system 200 may include a marketplace seller information DB 250, a product advertisement copying unit 260, a seller product DB 270, and a keyword and product click information DB 280.

The marketplace seller information DB 250 may include information about sellers in the marketplace system 200. The seller product DB 270 may include product information of the sellers in the marketplace system 200.

The product advertisement copying unit 260 may receive advertiser information from the advertiser information DB 415. Then, the product advertisement copying unit 260 may receive marketplace seller information that matches the advertiser information from the marketplace seller information DB 250. Also, the product advertisement copying unit 260 may receive product information of a seller registered with the marketplace system 200 from the seller product DB 270. The received data is advertiser product information. The product advertisement copying unit 260 sends the advertiser product information to the advertiser product DB 420 of the product advertisement management system 400.

The keyword and product click information DB 280 may send product click information to a category-keyword matching unit 440. The keyword and product click information DB 280 may include information about an input keyword which corresponds to a keyword used by a user to find products in the marketplace system 200, product categories of products found using the input keyword and then clicked, and the numbers of clicks on the products. However, the present inventive concept is not limited thereto.

FIG. 6 is a flowchart illustrating a product advertisement management method according to an embodiment of the present inventive concept.

Referring to FIG. 6, in the product advertisement management method according to the current embodiment, it is determined whether a keyword search has been conducted in an online marketplace 300 (operation S550). This can be determined based on whether a control unit 160 has received search keyword information. When it is determined that the keyword search has been conducted, the control unit 160 receives a search keyword online (operation S552). Then, the control unit 160 selects a matching category corresponding to a preset input keyword that matches the received search keyword by using a category-keyword matching DB 150 (operation S554). The matching category may be matched with a plurality of input keywords. The control unit 160 extracts product information corresponding to the matching category from a product advertisement DB 130 (operation S556). Then, the control unit 160 arranges the extracted product information in a preset order of bidding price (operation S570). For example, the control unit 160 may arrange the extracted product information in order of highest to lowest bidding price. The control unit 160 provides the product information in the arranged order (operation S575). The control unit 160 may provide the product information to the online marketplace 300, but the present inventive concept is not limited thereto. If it is determined in operation S550 that the keyword search has not been conducted, it is determined whether a category search has been conducted (operation S560). This may be determined based on whether the control unit 160 has received search category information. If it is determined that the category search has been conducted, the control unit 160 receives a search category online (operation S562). Then, the control unit 160 extracts product information corresponding to the search category from the product advertisement DB 130 (operation S564). The control unit 160 arranges the extracted product information in order of bidding price (operation S570). For example, the control unit 160 may arrange the product information in order of highest to lowest bidding price. Then, the control unit 160 provides the product information in the arranged order (operation S575). If it is determined in operation S560 that the category search has not been conducted, the whole process is terminated.

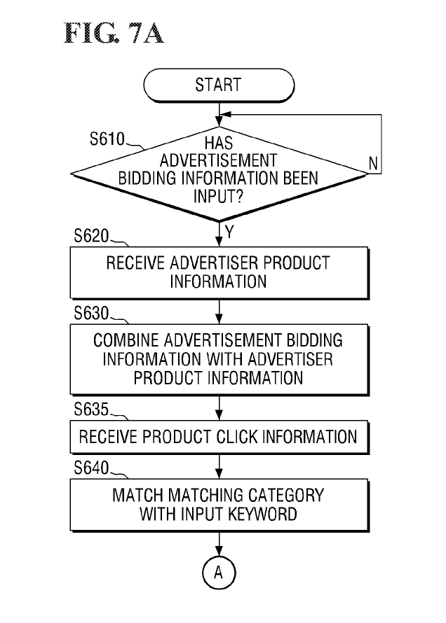

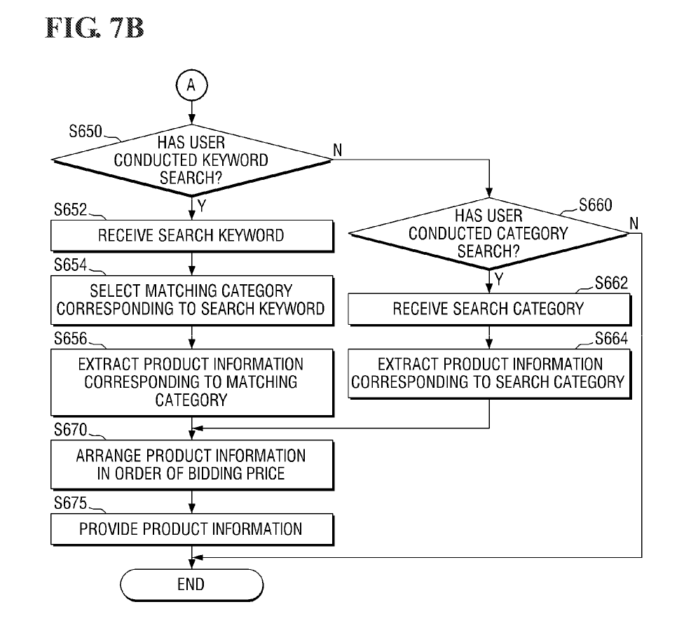

FIGS. 7A and 7B are flowcharts illustrating a product advertisement management method according to another embodiment of the present inventive concept. For simplicity, the current embodiment will be described, focusing mainly on differences with the embodiment of FIG. 6.

Referring to FIGS. 7A and 7B, in the product advertisement management method according to the current embodiment, advertisement bidding information including a product number and a bidding price is received through an input interface unit 110 (operation S610). If the advertisement bidding information has not been received, it is received again through the input interface unit 110. An advertiser product DB 120 receives advertiser product information (operation S620). The advertiser product DB 120 may receive the advertiser product information from one or more marketplace systems 200. An advertisement processing unit 125 combines the advertisement bidding information and the advertiser product information (operation S630). The advertisement processing unit 125 may add a bidding price item, which corresponds to the product number, to the advertisement product information. A category-keyword matching unit 140 receives product click information (operation S635). The product click information may include an input keyword, product categories, and the numbers of product clicks. The category-keyword matching unit 140 may match a matching category with the input keyword (operation S640). The matching category may be a category with a largest number of product clicks among product categories corresponding to the same input keyword. Operations S650 through S675 may be substantially the same as operations S550 through S575 described above with reference to FIG. 6.

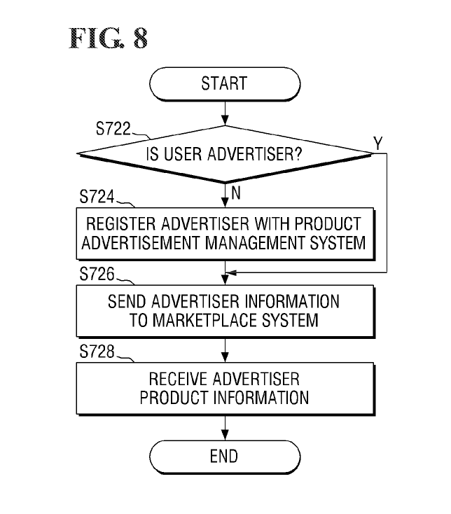

FIG. 8 is a flowchart illustrating the receiving of the advertiser product information (operation S620) of FIG. 7A.

Referring to FIG. 8, operations S722 through S728 may be detailed operations of the receiving of the advertiser product information (operation S620) of FIG. 7A. After operation S610 of FIG. 7A, it is determined whether a user is an advertiser of a product advertisement management system 400 (operation S722). If the user is not the advertiser of the product advertisement management system 400, advertiser information is registered in an advertiser information DB 415 by using the input interface unit 410 (operation S724). Then, the advertiser information is sent to a marketplace system 200 (operation S726). Advertiser product information corresponding to the advertiser information is received from the marketplace system 200 (operation S728). Subsequent operations are substantially the same as operations S630 through S675 of FIG. 7B. If the user is the advertiser pre-registered with the product advertisement management system 400, subsequent operations may be substantially the same as operations S726 through S728.

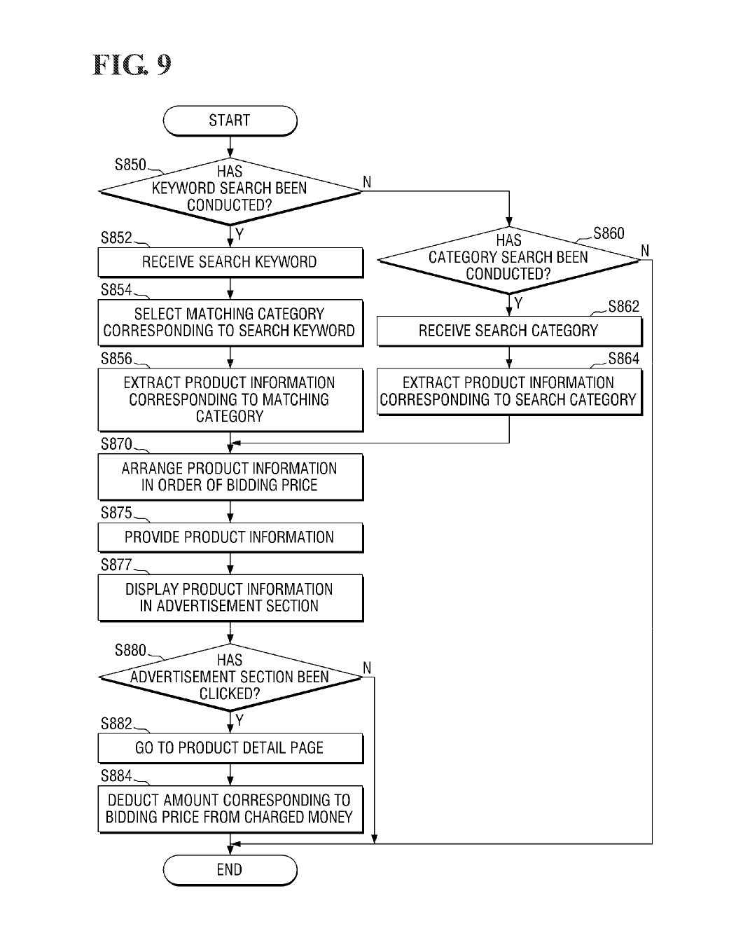

FIG. 9 is a flowchart illustrating a product advertisement management method according to another embodiment of the present inventive concept. For simplicity, the current embodiment will be described, focusing mainly on differences with the embodiment of FIG. 6.

Referring to FIG. 9, operations S850 through S875 of the product advertisement management method according to the current embodiment are substantially the same as operations S550 through S575 of FIG. 6. Next, a control unit 160 may display product information in an advertisement section (not shown) of an online marketplace 300 (operation S877). Specifically, the control unit 160 may display the product information in the advertisement section (not shown) in order of highest to lowest bidding price. Then, the online marketplace 300 determines whether a user has clicked on the advertisement section (not shown) (operation S880). When the user clicks on the product information in the advertisement section, the user is taken to a product detail page (not shown) (operation S882). The product detail page (not shown) may use information provided by a marketplace system 200, but the present inventive concept is not limited thereto. An amount corresponding to a bidding price for the clicked product information is deducted from an amount of charged money of an advertiser (operation S884). The amount of charged money of the advertiser may be managed in a charged money DB of a product advertisement management system 100.

According to a product advertisement management system and method according to the present inventive concept, there is no need to input advertisement information and advertisement landing page information. Since a seller can use information that he or she previously input to an online marketplace to sell products, an advertisement registration process can be simplified. In addition, there is no need to input a keyword for each product to be advertised. Instead, a product with a highest bidding price in each product category may be preferentially advertised, or a product with a highest bidding price in a matching category that matches a search keyword of a user may be preferentially advertised. This can increase the convenience of advertisers. Furthermore, a category of a product clicked most frequently among products found using a keyword input to an online marketplace and then clicked is selected as a matching category, and an advertisement is provided based on the matching category. Therefore, the efficiency of advertising can be increased.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims. It is therefore desired that the present embodiments be considered in all respects as illustrative and not restrictive, reference being made to the appended claims rather than the foregoing description to indicate the scope of the invention.

What is claimed is:

1. A product advertisement management system connected to an online marketplace and a marketplace system, the product advertisement management system comprising:
an input interface unit receiving advertisement bidding information which comprises a product number and a bidding price;
an advertisement processing unit combining the advertisement bidding information with data of an advertiser product database (DB);
a category-keyword matching unit receiving product click information which comprises an input keyword, product categories and the numbers of product clicks and selecting a matching category which is to be matched with the input keyword; and
a control unit displaying product information, which corresponds to the matching category matched with a search keyword of the online marketplace or corresponds to a search category, in order of bidding price,
wherein the category-keyword matching unit selects a product category with a largest number of product clicks as the matching category among the product categories corresponding to the same input keyword.

2. The product advertisement management system of claim 1, wherein the control unit receives the search keyword or the search category from the online marketplace and sends the product information arranged in order of highest to lowest bidding price to the online marketplace.

3. The product advertisement management system of claim 1, wherein the advertiser product DB receives advertiser product information from the marketplace system, wherein the advertiser product information comprises an advertiser ID, a product number, or a product category.

4. The product advertisement management system of claim 3, further comprising a product advertisement DB which provides the product information requested by the control unit to the control unit, wherein the advertisement processing unit sends data obtained by combining the product number of the advertiser product information with the bidding price corresponding to the product number to the product advertisement DB.

5. The product advertisement management system of claim 1, wherein the input keyword is a keyword used by a user to find products in the marketplace system, the product categories are categories of products found using the input keyword and then clicked, and each of the numbers of product clicks is the number of clicks on one of the products.

6. The product advertisement management system of claim 1, further comprising an advertiser information DB which stores advertiser information, wherein the input interface unit receives the advertiser information and sends the advertiser information to the advertiser information DB, the advertiser information DB sends the advertiser information to the marketplace system, and the advertiser product DB receives the advertiser product information from the marketplace system.

7. A product advertisement management method comprising the steps of:
receiving a search keyword or a search category online;
extracting product information which corresponds to a matching category for a preset input keyword that matches the received search keyword or product information which corresponds to the received search category; and
displaying the product information in a preset order of bidding price,
wherein the matching category is a product category with a largest number of product clicks among product categories corresponding to the same input keyword.

8. The method of claim 7, wherein the step of extracting the product information comprises the steps of:
receiving product click information which comprises the input keyword, the product categories, and the numbers of product clicks;
matching the matching category with the input keyword; and
extracting product information of the product category from a product advertisement DB.

9. The method of claim 8, wherein the matching category can be matched with a plurality of input keywords.

10. The method of claim 8, further comprising the steps of:
receiving advertisement bidding information which comprises a product number and a bidding price; and
combining the advertisement bidding information with data of the advertiser product DB and sending the combined data to the product advertisement DB.

11. The method of claim 7, further comprising the steps of:
receiving and registering advertiser information of an advertiser;
sending the advertiser information to a marketplace system; and
receiving advertiser product information of the advertiser from the marketplace system.

12. The method of claim 7, wherein the step of displaying the product information comprises displaying the product information in an advertisement section in order of highest to lowest bidding price and further comprising, when a user clicks on the product information, taking the user to a product detail page and deducting an amount corresponding to the bidding price from an amount of charged money.
